(19) United States
(12) Patent Application Publication
(10) Pub. No.: US 2004/0204074 A1
(43) Pub. Date: Oct. 14, 2004

(54) Cellular phone speaker console

(76) Inventor: Nimesh R. Desai, Los Angeles, CA (US)

Correspondence Address: Nimesh R Desai, 11693 San Vicente Boulevard, No 396, Los Angeles, CA, 90049, US

(21) Appl. No.: 10/147,393

(22) Filed: May 16, 2002

(51) Int. Cl. H04B 1/38

(52) U.S. Cl. 455/557; 455/573; 455/566; 455/563; 455/564; 455/556.1

(57) ABSTRACT

A system for providing a console for a mobile phone is disclosed. A connector for mating in communicative relationship with a mobile phone is included. The console has a microphone, a speaker, and a controller configured to disable audio functions of the mobile phone when the mobile phone is mated to the console. The system further comprises a battery charger for charging a battery of the mobile phone when the mobile phone is mated with the console. The system further comprises a keypad for functioning in place of a keypad on the mobile phone when the mobile phone is mated to the console. A console display is further included for display operations on the console. A data port is coupled to the console for transferring data between the mobile phone and another electronic device, or between the console and another electronic device.

The present invention relates generally to a cellular phone speaker console. More particularly, and although not exclusively, the present invention relates to a system and method providing a console for a mobile phone that allows speaker, keypad, and data communications for a cellular telephone or mobile communicator.

### BACKGROUND OF THE INVENTION

Current mobile telephones, also commonly referred to as radiotelephones, cellular telephones, mobile stations, and personal communicators, typically include a connector port to permit the mobile phone to be temporarily hardwired to a base unit when the mobile phone is used in an automobile or other moving vehicle. The base unit forms part of a “car kit”, which includes accessories such as a speakerphone, answering machine, data communications electronics, car-mounted antenna, etc. A mobile phone holder (or “cradle”) is mounted to the dashboard, central glove compartment or pedestal mount. The holder retains the mobile phone when not in use or during speakerphone (hands-free) operation.

U.S. Pat. No. 6,236,868 discloses a mobile phone that is retainable within a central slot of a plastic holder mounted to the automobile's dashboard. The mobile phone is electrically connected via a plug and cord to a portable base unit, which is typically mounted to the central glove compartment of the vehicle. A base unit is connected to the vehicle's +12V power supply which powers the base unit and recharges the mobile phone's battery via leads within a cable. The base unit is usually connected to a car-mounted antenna. A battery charger/eliminator and speakerphone electronics are typically built into the base unit. Speakerphone electronics include an audio pickup as well as amplification electronics for driving an external speaker. The audio pickup may be located external to the base unit, such as in the sun visor, by means of another hard wire connection from the base unit. An apparatus is provided for sensing the presence of the mobile phone within the holder to switch on the base unit to activate the speakerphone and allow hands-free phone operation.

Systems heretofore do not provide, however, a display on the mobile phone holder for providing an alternative, or additional, display for mobile phone operation. Nor do previous systems provide a data port for transferring data between the mobile phone and another electronic device, or between the mobile phone holder and another electronic device.

### BRIEF SUMMARY OF THE INVENTION

A system for providing a console for a mobile phone is disclosed. A connector for mating in communicative relationship with a mobile phone is included. The console has a microphone, a speaker, and a controller configured to disable audio functions of the mobile phone when the mobile phone is mated to the console. The system further comprises a battery charger for charging a battery of the mobile phone when the mobile phone is mated with the console. The system further comprises a keypad for functioning in place of a keypad on the mobile phone when the mobile phone is mated to the console. A console display is further included for display operations on the console. A data port is coupled to the console for transferring data between the mobile phone and another electronic device, or between the console and another electronic device.

The console may either be mobile itself, such as for an automobile or airplane, or the console may be stationary for use in, for example, an office, conference room or home.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a system that operates in accordance with the present invention;

FIG. 2 is a block diagram illustrating some of the components of the console and mobile phone of FIG. 1; and

FIGS. 3A-3B are flow diagrams illustrating a method performed by the system of FIG. 1.

### DETAILED DESCRIPTION OF THE PREFERRED EMBODIMENTS

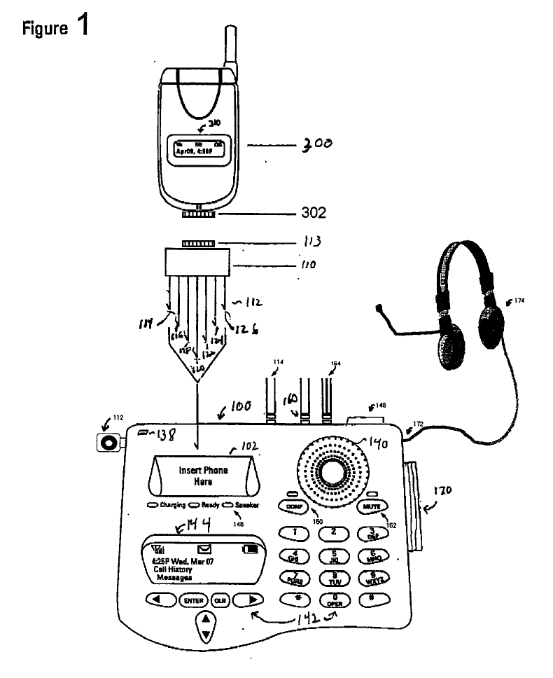

With reference to FIG. 1, a high-level architectural drawing illustrating the primary components of a desktop system that operates in accordance with the present invention is shown. The desktop system comprises a console 100 having a connector for a mobile phone 300. The console 100 mates in communicative relationship with a mobile phone 300 by way of an insertion slot 102 in the console 100. The insertion slot 102 includes an adaptor 110 (expanded for clarity in FIG. 1) with a pin-out 112 for conversion of signals from the mobile phone to standard output compatible with the console 100. The adaptor 110 further includes a connector 113 for mating with a corresponding connector 302 on the cell phone 300.

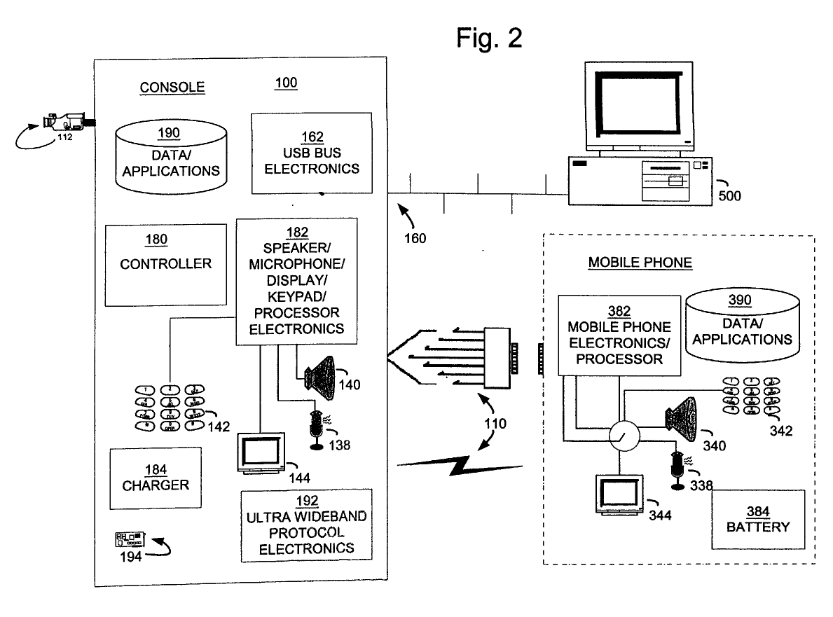

Alternatively, the mobile phone 300 is connected to the console 100 via a cable connector instead of using the insertion slot 102. As another alternative, the mobile phone 300 may have an infrared transceiver for communicating with the adaptor 110, which would be, in this case, an infrared transceiver connected to the console 100. In yet another embodiment, the transceiver on the mobile phone 300 may comprise a BLUETOOTH, UTRA WIDEBAND or IEEE 802.11x standard wireless transceiver, and the adaptor 110 may comprise the same so that wireless communications may occur instead of communications via a physical connection (see 110 in FIG. 2). For the embodiment using wireless communications, wireless electronics 192 are used to convert the protocol normally used with the adaptor 110 into wireless protocol.

For the physical connection embodiment, the pin-out 112 for the adaptor 110 may comprise a ground pin 114, direct current (DC) voltage pins 116, keypad data pins 118, display data pins 120, serial connection pins 122, microphone data pins 124, and speaker data pins. Depending on the manufacturer of the cell phone 300, the adaptor converts the pin-out 112 to comply with the manufactured specified pin-out of the cell phone connector 302 that is mated with the adaptor connector 113.

A power connector 164 is included which may comprise either AC or DC input, including input from, for example, a wall outlet, or an automobile or airplane power plug. If the input is AC, then a plug type converter may be used to convert the power input from AC to DC, or the converter may be included in the console 100.

The console 100 includes a microphone 138 and a speaker 140. Alternatively to having a separate microphone 138 and speaker 140, the microphone 138 and speaker 140 may be integrated into one microphone-speaker unit 140. Both the microphone 138 and speaker 140 or microphone-speaker 140 are/is activated when the mobile phone is mated with the console 100. The console may further include a headset connector or jack 172, in standard format, for attaching a headset 174 thereto. The headset 174 operates in substitution for the speaker 140 and microphone 138. Just as the connection between the mobile phone 300 and the console 100 may be a wireless transceiver, so too may be the connector 172 between the console 100 and the headset 174 to send and receive audio signals to and from the headset 174.

A keypad 142 is included for functioning in place of a keypad on the mobile phone 300 when the mobile phone is mated to the console 100. Similarly to operation with the microphone 138 and speaker, the keypad 142 is activated when the mobile phone is mated with the console 100.

With reference to FIG. 2, a block diagram illustrating some of the components of the console 100 and mobile phone 300 of FIG. 1 is shown. The console 100 includes a controller 180 configured to send a signal to a set of mobile phone electronics 382 which disables the mobile phone's microphone 338, speaker 340, display, 344 and keypad 342 when the mobile phone 300 is mated or plugged into the console 100. The controller 180 controls activation of the console's microphone 138 and speaker 140 through a set of electronics 182 in the console 100.

The console's keypad 142 further includes a muting input device or mute button (152 in FIG. 1), which is used to disable the microphone 138 if pressed during a phone call. The console's electronics 100 detect the pressing of the mute button 152, and block audio signals received from the microphone 138, preventing the audio signals from reaching the mobile phone 300. The console electronics 182 re-enable the audio input from the microphone 138 if the mute button 138 is pressed again. Alternatively, the muting input device 152 may comprise a menu selection selected using the keypad 142 and console display 144.

A conference call input device or conference button (150 in FIG. 1) is provided so that at least three-way calling operation is provided with the console 100 if pressed. Typically, when using conference calling on a mobile phone 300, the user must use a more complex series of button presses than in desktop telephones because of the special nature of cellular operation. Typically, users must work through a series menu selections on the mobile phone 300 in order to make a conference call. The operation of the conference button 150 in the present invention eliminates this problem by using the console electronics 182 to convert the simple pressing of the conference button 150 into the necessary commands to transmit to the mobile phone 300 to execute the conference call. Just like operation with normal desktop landline phones, the user merely needs to press the conference button 150 and dial, or use voice recognition to dial and conference in another party. After initiating a conference operation to add the a party to the call, yet another party may be added by repeating the same operation. Throughout the process, the console electronics 182 converts and sends the proper commands to the mobile phone 300 to execute the conference call as if the user had proceeded through the complex steps to initiate conferencing on the mobile phone 300.

The console 100 further comprises a console display 144 (FIGS. 1 and 2). The controller 180 activates the display 144 when the mobile phone 300 is mated with the console 100. The console display 144 is for displaying the output of a mobile phone display 302. The console display 144 may also provide enhanced display functions. Such enhanced display functions may comprise a color display, display of messaging services, and/or display of internet data such as web pages.

The console 100 comprises a battery charger 184 for charging a battery 384 of the mobile phone 300 when the mobile phone 300 is mated with the console 100. DC voltage is provided from the console 100 through the DC voltage pins 116 for charging. For embodiments using an wireless adaptor 110, DC voltage is provided separately from the adaptor 110.

The console 100 further comprises a data communication port 160 for connecting the console 100 to an electronic device 500 for providing communications between the electronic device 500 and the mobile phone 300. This way, certain data can be updated to the mobile phone 300 from the electronic device 500. For example, many modern mobile phones 300 have personal digital assistant (PDA) functionality, such as phone number storage, search, auto-dialing, and calendaring functions. The electronic device 500 may comprise a personal computer or a PDA, the data port 160 comprising a USB port providing a data path for synchronizing data between the mobile phone 300 and the electronic device. The console 100 contains a USB bus controller 162 for operating the data port 160. The electronic device 500 may thus include synchronization capability using, for example, MICROSOFT ACTIVESYNC by the Microsoft Corporation, with such applications such as MICORSOFT OUTLOOK. The console 100 provides a signal to the electronic device 500 indicating that the mobile phone 300 has been attached. ACTIVESYNC would then automatically synchronize data between the electronic device and the mobile phone 300 through the console 100, including a contacts or phone list. Similar to the wireless embodiments described above for the connections to the mobile phone 300 and/or the headset 174, as an alternative to a USB or physical connection, the data port 160 between the electronic device 500 and the console 100 may be wireless using, for example, BLUETOOTH, ULTRA WIDEBAND or IEEE 802.11x known technology.

The mobile phone 300 also includes a storage device 390 for storing synchronized data, including a phone number storage. The synchronized data allows the user to automatically dial a phone number from a database of phone numbers that is retrieved from the storage device 390 of the mobile phone 300. Once the phone number database is loaded into the mobile phone 300, the user may then scroll through names and phone numbers that have been loaded and synchronized with the phone number storage in the storage device 390. Those familiar with operation of mobile phones 300 capable of using phone number dialing databases would appreciate this capability. Further, new uses for phone number databases in mobile phones 300 are emerging, such as voice dialing, which allows the user to speak the name of the person or organization they are dialing into the mobile phone's speaker, matching the spoken name to the name in the phone number database, and then automatically dialing the matched number for the user hands free. The console 100 of the present invention allows this same capability when the mobile phone 300 is mated to the console 300. Input for the voice dialing is diverted from the microphone 338 of the mobile phone 300 to the console's microphone 138.

The console 100 further comprises a printer docking port (146 in FIG. 1). The printer docking port 146 may be used for printing operations for applications executing either on the mobile phone 300 or the console 100, or both.

Some mobile phones 300 have specialized processors and large displays 344 to run software or firmware applications normally reserved for personal computers or PDA devices. When mated with the console 100, display and audio input and output for applications executing on the mobile phone 300 are diverted to the display 144, microphone 138 and speaker 140 of the console 100.

The console's electronics 182 includes a processor for executing software applications stored in a storage device 190 in the console 100. The storage device 190 further stores data used by the applications. The data storage devices 190 and 390 may each comprise, for example, a solid-state memory device such as flash memory, a hard disk unit, CD-ROM, CD-RW, or WORM device. Random access memory (RAM) may also be used for, or provided with, the data storage devices 190 and 390 for temporary storage of executing software applications and application data.

In some cases, because of the limited storage capacity of most mobile phones 300 the data storage device 190 on the console 100 may store applications that have code that is executable on the mobile phone 300. One or more of the software applications may be uploaded to the storage device 390 of the mobile phone 300 temporarily for execution on the mobile phone 300. When a new application needs to be uploaded, and there is not enough storage capacity left on the mobile phone 300, then an unused application that was previously uploaded may be erased from the storage device 390 of the mobile phone 300, only to be uploaded again when needed. Alternatively, if the user knows that he is going to need to use an application while away from the console, he may decide to upload software from the console 100 or electronic device 500 so it may be used at a later time when the mobile phone 300 is not mated with the console 100.

Voice recognition software is an example of a software application that may either be executed on the processor of the mobile phone 300 or the processor 182 of the console 100. Voice recognition software may be used to enable the aforementioned voice dialing capability. When voice dialing is required, the user may activate the voice dialing feature by either selection of an option from a menu using the keypad 142 and display 144, or a user may speak into the microphone 138 or 140 giving an activation command such as saying the words—voice dial—or other words to that affect. In the latter case, a small kernal from voice recognition application software, running either on the mobile phone 300 or console 100, recognizes that the activation command has been spoken by the user. At that point, if the fill 10 voice recognition software application is not already loaded into either the data storage device 390 of the mobile phone 100, or the console's RAM 190, the full voice recognition software is loaded either into the memory 390 of the mobile phone 300, or the console's RAM 190, depending on the way the console 100 is configured. There may be a preference for loading the voice recognition software into either the memory 190 of the mobile phone 100 or the console's RAM 190 depending on, for example memory capacity or processor speed, creating a hierarchy of software loading much like virtual memory by MICROSOFT Corp. used in the WINDOWS operating system. The voice recognition software may then sample the asked for name spoken by the user, and then look up the name in either the synchronized name storage in the storage device 390 of the mobile phone 300, or in the console's storage device 190, or both. Once the phone number is retrieved, a dial command is sent to the mobile phone 300 and executed.

Other software applications stored on either storage device 190 or 390 include point of sale applications that can be used either with the internet, or customized secure purchasing applications using direct dial line connects through the mobile phone 300. For example, the 25 console 100 may further comprise a magnetic swipe reader (170 in FIG. 1) configured to read data stored on a magnetic strip of, for example, a credit card. In this way, the mobile phone 300 and console 100 combination provides point of sale functions.

Hardware may be included with the console 100 for establishing a network or internet connection (114 in FIG. 1). Such hardware may include, for example, a network adaptor or eithernet adaptor 194 which can be used to attach to a network or the internet for internet browsing, or for voice over data operations.

A video, or CCD, camera (112 in FIG. 1) may also be attached to the console. Small, full motion video cameras, such as the QUICKCAM PRO sold by LOGITECH of Fremont, Calif., are becoming more prevalent for capturing video for instant transmission or video capture. The video camera 112 may be used for allowing video conferencing operations either by transmission of video and audio signals through the mobile phone 300 or through the internet using the eithernet adaptor 194. The electronics 182 and controller may contain logic for configuring the console 100 to use the video camera 112, network adaptor 194 and display 144 for video conferencing. Video conferencing software stored in the storage device 190 may also be loaded and used for configuration of the console 100 for video conferencing. There are many applications for this combination mobile phone 300 and video, audio, and data transmission capability. For example, video conferencing may be three way, with signals being transmitted and received through the mobile phone 300 and the network adaptor 194 simultaneously. This allows great versatility for multi-network communications using the console 100. Part of the enhanced display operations in console 100 comprises displaying the video for video conferencing operations on the display 144.

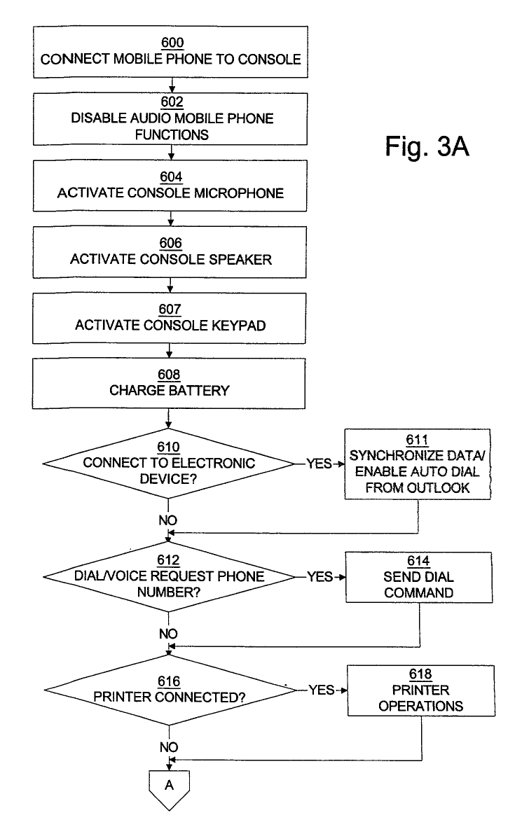

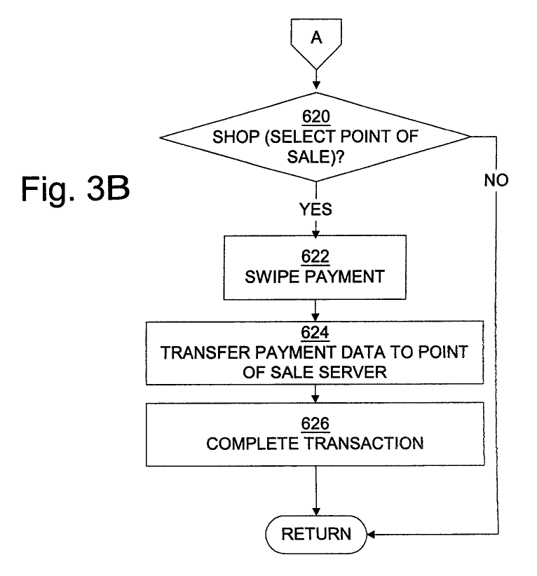

With reference to FIGS. 3A-3B, one aspect of the present invention comprises a method for providing a console 100 for a mobile phone 300, the steps of which are shown in the flow diagrams of FIGS. 3A-3B. The process starts by connecting a mobile phone 300 to a console 100, step 600. The audio functions of the mobile phone 300 are disabled when a connection between the mobile phone 300 and console 100 is detected, step 602. The microphone 138 or 140, coupled with the console 100, is activated, step 604. The speaker 140, coupled to the console, is also activated, step 606. If the headset 174 is in use with the console 100, then, in steps 604-606, the headset 174 is activated instead of the speaker 140 and microphone 138 until the headset 174 is either unplugged or deactivated. The keypad 142 is further activated, step 607. The battery charger 184 then begins charging the battery of the mobile phone 300, step 608.

The user may connect the console 100 to an electronic device 500 via the data communications port 160, step 610. Data synchronizing between the mobile phone 300 and the electronic device 500 may then take place through the console 100, step 611. In step 611, further enhanced voice dialing operations may be enabled wherein the console 100 may further check the database of names, e.g. OUTLOOK contacts, on the electronic device 500 as well as on the console 100 and mobile phone 300 to search for matching names.

The user may dial a phone number by either using the keypad 142 or using voice dialing, step 612. When either occurs, a dial command is sent to the mobile phone 300, step 614.

The user may connect the console 100 to a printer, step 616. Depending on the software applications running on either the mobile phone 300 or the console, printer operations may then proceed, step 618.

The user may use the mobile phone 300 as a point of sale device by either navigating to a web page allowing point of sale functions using the keypad 142, or selecting a point of sale application from a menu on the display 144, step 620. When called for by the point of sale program or web page, the user may then swipe a credit card on the magnetic strip reader 170, step 622. The data stored on the magnetic strip of the credit card is then transferred from the console, through the mobile phone 300, to the relevant point of sale server, step 624 being accessed by either the point of sale software or the accessed web site. The web page or point of sale software may then guide the user through completion of the transaction, step 626.

Although the invention has been described in terms specific types of elements, as well as with reference to certain methodological acts, it is to be understood that the invention defined in the appended claims is not necessarily limited to the specific structures or acts described. The specific structural features and acts therefore are disclosed as exemplary embodiments implementing the claimed invention.

Further, the embodiments described above are provided by way of illustration only and should not be construed to limit the invention. Those skilled in the art will readily recognize various modifications and changes that may be made to the present invention without following the exemplary embodiments and applications illustrated and described herein, and without departing from the scope of the present invention, which is set forth in the following claims.

What is claimed is:

1. A console for a mobile phone, comprising:
a connector for mating in communicative relationship with a mobile phone;
a microphone;
a speaker
a data communication port for connecting the console to an electronic device; and a controller configured to disable a keypad on the mobile phone, and to disable audio functions of the mobile phone, when the mobile phone is mated to the connector.

2. The console of claim 1, further comprising a battery charger, the battery charger for charging a battery of the mobile phone when the mobile phone is mated with the connector.

3. The console of claim 1, comprising a keypad is for functioning in place of a keypad on the mobile phone when the mobile phone is mated to the connector.

4. The console of claim 1, further comprising a console display.

5. The console of claim 4, wherein the console display is for displaying the output of a mobile phone display.

6. The console of claim 4, wherein the console display is for providing enhanced display functions.

7. The console of claim 6, wherein one of the enhanced display functions comprises color display.

8. The console of claim 6, wherein one of the enhanced display functions comprises messaging services.

9. The console of claim 6, wherein one of the enhanced display functions comprises display of internet data.

10. The console of claim 1, wherein the data communication port is for connecting the console to an electronic device for providing two-way data communications between the electronic device and the mobile phone.

11. The console of claim 10, wherein the data communication port provides a data path for synchronizing data between the mobile phone and the electronic device.

12. The console of claim 11, wherein the synchronized data comprises data that allows the user to automatically dial a phone number from a database of phone numbers.

13. The console of claim 10, wherein the electronic device is a personal computer.

14. The console of claim 10, wherein the electronic device is a personal digital assistant.

15. The console of claim 1, further comprising a printer docking port.

16. The console of claim 1, further comprising a data storage device.

17. The console of claim 16, wherein the data storage device comprises a solid state memory device.

18. The console of claim 16, wherein the data storage device comprises a hard disk memory device.

19. The console of claim 16, wherein the data storage device is for storing software for execution on a processor in the mobile phone.

20. The console of claim 16, wherein the data storage device is for storing software for execution on a processor in the console.

21. The console of claim 1, further comprising:
a voice recognition system; and
a processor, the processor configured to process voice recognition based dialing of the mobile phone.

22. The console of claim 1, further comprising a magnetic swipe reader, the magnetic swipe reader configured to read data stored on a magnetic strip.

23. The console of claim 22, wherein the magnetic swipe reader is for providing point of sale functions.

24. The console of claim 1, further comprising a headset connector for receiving a headset for use in place of the speaker and microphone.

25. The console of claim 24, wherein the headset connector comprises a wireless transceiver for transmitting and receiving audio signals to and from a the headset.

26. A system for providing a console for a mobile phone, comprising:
a connector for mating in communicative relationship with a mobile phone;
a microphone;
a speaker;
a console display;
a keypad, the keypad configured to function in place of a keypad on the mobile phone when the mobile phone is mated to the console; and
a controller configured to disable audio functions of the mobile phone when the mobile phone is mated to the console.

27. A system for providing a console for a mobile phone, comprising:
a connector for mating in communicative relationship with a mobile phone;
a microphone;
a speaker;
a console display;
a data communication port for connecting the console to an electronic device for providing communication between the electronic device and the mobile phone;
a keypad, the keypad configured to function in place of a keypad on the mobile phone when the mobile phone is mated to the console; and
a controller configured to disable audio functions of the mobile phone when the mobile phone is mated to the console.

28. The system of claim 27, wherein the data communication port provides a data path for synchronizing data between the mobile phone and the electronic device.

29. The system of claim 28, wherein the synchronized data comprises data that allows the user to automatically dial a phone number from a database of phone numbers.

30. The system of claim 28, wherein the electronic device is a personal computer.

31. The system of claim 28, wherein the electronic device is a personal digital assistant.

32. A system for providing a console for a mobile phone, comprising:
a connector for mating in communicative relationship with a mobile phone;
a microphone;
a speaker;
a data communication port for connecting the console to an electronic device for providing communication between the electronic device and the mobile phone;
a keypad, the keypad configured to function in place of a keypad on the mobile phone when the mobile phone is mated to the console; and
a controller configured to disable audio functions of the mobile phone when the mobile phone is mated to the console.

33. A system for providing a console for a mobile phone, comprising:
a connector for mating in communicative relationship with a mobile phone;
a microphone;
a speaker;
a console display;
a data communication port for connecting the console to an electronic device for providing communication between the electronic device and the mobile phone, wherein the data communication port provides a data path for synchronizing data between the mobile phone and the electronic device;
a keypad, the keypad configured to function in place of a keypad on the mobile phone when the mobile phone is mated to the console; and
a controller configured to disable audio functions of the mobile phone when the mobile phone is mated to the console.

34. A system for providing a console for a mobile phone, comprising:
a connector for mating in communicative relationship with a mobile phone;
a microphone;
a speaker;
a voice recognition system;
a processor, the processor configured to process voice recognition based dialing of the mobile phone;
a keypad, the keypad configured to function in place of a keypad on the mobile phone when the mobile phone is mated to the console; and
a controller configured to disable audio functions of the mobile phone when the mobile phone is mated to the console.

35. A system for providing a console for a mobile phone, comprising:
a connector for mating in communicative relationship with a mobile phone;
a microphone;
a speaker;
a console display;
a voice recognition system;
a processor, the processor configured to process voice recognition based dialing of the mobile phone;
a data communication port for connecting the console to an electronic device for providing communication between the electronic device and the mobile phone;
a keypad, the keypad configured to function in place of a keypad on the mobile phone when the mobile phone is mated to the console; and
a controller configured to disable audio functions of the mobile phone when the mobile phone is mated to the console.

36. A system for providing a console for a mobile phone, comprising:
a connector for mating in communicative relationship with a mobile phone;
a microphone;
a speaker;
a voice recognition system;
a processor, the processor configured to process voice recognition based dialing of the mobile phone;
a data communication port for connecting the console to an electronic device for providing communication between the electronic device and the mobile phone;
a keypad, the keypad configured to function in place of a keypad on the mobile phone when the mobile phone is mated to the console; and
a controller configured to disable audio functions of the mobile phone when the mobile phone is mated to the console.

37. A method for providing a console for a mobile phone, comprising:
connecting a mobile phone to the console;
disabling the audio functions of the mobile phone when the mobile phone is connected to the console;
activating a microphone coupled to the console;
activating a speaker coupled to the console; and
activating a display coupled to the console.

38. The method of claim 37, wherein the mobile phone is connected to the console via a cable.

39. The method of claim 37, wherein a controller is configured for disabling the audio functions of the mobile phone.

40. The method of claim 39, wherein the controller is configured for activating the microphone.

41. The method of claim 39, wherein the controller is configured for activating the speaker.

42. The method of claim 37, further comprising dialing a phone number on a keypad coupled to the console.

43. The method of claim 37, further comprising charging a battery of the mobile phone when the mobile phone is connected to the console.

44. The method of claim 37, further comprising connecting the console to an electronic device via a data communications port.

45. The method of claim 44, wherein the electronic device is a personal computer.

46. The method of claim 44, wherein the electronic device is a personal digital assistant.

47. The method of claim 44, further comprising synchronizing data between the mobile phone and the electronic device.

48. The method of claim 47, further comprising dialing a phone number based on data from the electronic device.

49. The method of claim 37, further comprising connecting the mobile phone to a printer docking port.

50. The method of claim 37, further comprising storing data on a data storage device, the data storage device adapted for communicating with the console.

51. The method of claim 50, wherein the data storage device comprises a solid state memory device.

52. The method of claim 50, wherein the data storage device comprises a hard disk memory device.

53. The method of claim 50, wherein the data storage device comprises a device for storing software for execution on a processor in the mobile phone.

54. The method of claim 50, wherein the data storage device comprises a device for storing software for execution on a processor in the console.

55. The method of claim 37, further comprising dialing a phone number based on voice commands.

56. The method of claim 37, further comprising transferring data stored on a magnetic strip via a magnetic swipe reader, the magnetic swipe reader coupled with the console.

57. The method of claim 37, wherein the step of connecting comprises connecting the mobile phone to the console wirelessly.

58. The method of claim 37, further comprising connecting a headset to the console for use in place of the speaker and microphone.

59. A desktop console for a mobile phone, comprising:
a connector for mating in communicative relationship with a mobile phone;
a microphone;
a speaker
a data communication port for connecting the console to an electronic device; and
a controller configured to disable a keypad on the mobile phone, and to disable audio functions of the mobile phone, when the mobile phone is mated to the connector.

60. A console for a mobile phone, comprising:
a connector for mating in communicative relationship with a mobile phone;
a microphone;
a speaker; and
a muting input device for causing the blocking of signals received by the microphone from transmission through the mobile phone.

61. A console for a mobile phone, comprising:
a connector for mating in communicative relationship with a mobile phone;
a microphone;
a speaker; and
a video camera for capturing video images.

62. The console of claim 61, wherein the video camera is for capturing video signals for transmission.

63. The console of claim 62, wherein the video camera is for capturing video signals for video conferencing.

64. A console for a mobile phone, comprising:
a connector for mating in communicative relationship with a mobile phone;
a microphone;
a speaker; and
a network adaptor.

65. The console of claim 64, wherein the network adaptor is for data transmission over a network.

66. The console of claim 65, wherein the network comprises the internet.

67. A console for a mobile phone, comprising:
a connector for mating in communicative relationship with a mobile phone;
a microphone;
a speaker;
a display
a video camera for capturing video images; and
a network adaptor.

68. The console of claim 67, wherein the console is configured to use the video camera, network adaptor and display for video conferencing.

69. A console for a mobile phone, comprising:
a connector for mating in communicative relationship with a mobile phone;
a microphone;
a speaker; and
a conference call input device for causing the console to receive input for conferencing two or more other parties with a user of the console, and to cause the console to provide commands to the mobile phone for conferencing the two or more parties with the user of the console.
